(19) United States
(12) Patent Application Publication
(10) Pub. No.: US 2004/0241281 A1
(43) Pub. Date: Dec. 2, 2004

(54) Alcoholic beverage

(75) Inventor: Steve Ramsden, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA

(21) Appl. No.: 10/803,348

(22) Filed: Mar. 18, 2004

Related U.S. Application Data
(60) Provisional application No. 60/455,900, filed on Mar. 19, 2003.

(51) Int. Cl. C12C 11/00

(52) U.S. Cl. 426/11

(57) ABSTRACT

The invention provides a method of producing a fermented beverage. A starch hydrolysate is fermented in the presence of yeast, a soluble nitrogenous yeast nutrient source, and an enzyme that releases fermentable carbohydrates from the starch hydrolysate to achieve a fermented beverage. The soluble nitrogenous yeast nutrient source is present in an amount sufficient to sustain fermentation of the starch hydrolysate to an inactivating alcohol concentration in the fermented beverage without being rate-limiting in the fermentation. The method can further comprise carbon filtration and ion exchange filtration to substantially remove impurities. A fermented beverage having substantially neutral flavor and substantially neutral odor prepared in accordance with the inventive method also is provided.

### RELATED APPLICATION

This application claims priority to prior provisional application 60/455,900 filed Mar. 19, 2003. The entire contents of the prior provisional application are hereby incorporated by reference in their entireties.

### FIELD OF THE INVENTION

This invention pertains to fermented beverages and methods of producing same.

### BACKGROUND OF THE INVENTION

The prior art has provided innumerable varieties of fermented and distilled alcoholic beverages. Beer and wine are generated by fermenting sugars found in or derived from grain- or fruit-based mashes or musts. Distilled spirits also are generated from fermentation of a mash, but undergo subsequent distillation to increase the alcohol content, and, in most cases, to modify the flavor, color, and aroma of the product. Most distilled products are aged to further modify flavor, aroma, and color.

Generally, in the art of fermented alcoholic beverages, efforts are made to impart flavor to or enhance flavors in the finished product. For example, beers are produced using carefully selected starting materials, e.g., combinations of barley, wheat, hops, and the like, which impart distinctive flavors and aromas to the finished product. Brewers take steps to enhance the flavor of the beer, for instance by toasting the barley malt used to prepare the beer, by selecting other germinated grains (e.g. wheat) and by selecting other ingredients (in particular hops) to add flavor to the beer. In winemaking, vintners will vary the fruit must, the fermentation parameters, and the vessels used for storing and aging the wine. Wines are generally allowed to ferment for a lengthy period (7-21 days) to allow the wines to develop complex flavor-and aroma-producing components. Through such techniques, a variety of wines with an infinitely complex spectrum of flavors and aromas may be produced. In the case of distilled spirits other than grain neutral spirits, the fermentable starting material has an enormous impact on the flavor and character of the distilled beverage, as does the type of vessel selected for storing and aging the spirits.

All of the foregoing procedures and operating parameters are designed to add or modify flavor-and aroma-generating components in the beverage. In the fermented beverage arts, occasionally efforts are made to provide a colorless and flavorless product. Such products can be sold “as is,” or flavoring agents subsequently can be added to provide a flavored beverage. Recently, there has been a growing consumer interest in neutral beverages that have been flavored with citrus or other non-grain flavorings.

It has long been known in the art to provide a clear, flavorless beverage via distillation of a fermented alcoholic mixture to the eutectic point of the mixture, followed by filtration and decolorization of the resulting product. The resulting distilled beverage, termed a “grain neutral spirit,” is sold at commodity levels for various uses in the beverage industry. Although such distilled neutral-tasting beverages are often commercially acceptable, distillation is not appropriate under all circumstances. Distillation is costly and time intensive, and increases the alcohol-content of the product, thus requiring dilution if a lower alcohol content is desired. In addition, beverages containing distilled spirits are treated differently from fermented beverages for tax purposes.

In an effort to keep up with consumer demand for new products, and in a socially responsible effort to provide beverages with a low alcohol content (under about 9%), the beverage industry has introduced numerous neutral alcoholic beverages that are prepared by methods other than distillation. For example, U.S. Pat. No. 4,990,350 purportedly describes a beverage having a reduced alcohol content that is said to be produced without dilution of distilled spirits. Many efforts have been made to prepare a neutral-tasting beverage from malted barley (malt). For instance, U.S. Pat. No. 5,294,450 purportedly describes a colorless malt beverage product that is said to minimize consumer sensations of fullness and to provide attractive taste characteristics. The prior art reflects numerous efforts to supplement the malt with carbohydrate adjuncts and to ferment the malt/adjunct mixture under controlled conditions to yield a neutral beverage or beverage base. For instance, U.S. Pat. No. 4,495,204 describes a neutral-tasting beverage made from malt and dextrose. U.S. Pat. No. 3,798,331 describes an alcoholic beverage made from malt, sucrose, and soya flakes. U.S. Pat. No. 3,332,779 discusses the preparation of a neutral beverage prepared from malt and glucose. U.S. Pat. No. 4,021,580 describes preparation of a neutral beverage from malt and corn syrup. Other adjuncts are described in U.S. Pat. No. 3,908,021.

Notwithstanding the foregoing, there remains room for improvement over the heretofore described art. The foregoing non-distilled beverages are believed to have a characteristic malt-like flavor. Techniques of purifying fermented products, such as ultrafiltration (see, e.g., U.S. Pat. No. 5,439,699) have been proposed, but such techniques have proven inefficient or unsuccessful in providing the desired flavor-neutral alcoholic product.

In view of the above, the invention seeks to provide in preferred embodiments a fermented, non-distilled beverage that is colorless, flavorless and odorless.

### THE INVENTION

The invention provides a method for preparing a fermented beverage, and, in preferred embodiments, a beverage that is colorless, flavorless, and odorless, and organoleptically neutral. The method comprises providing a starch hydrolysate and fermenting the starch hydrolysate in the presence of yeast, a soluble nitrogenous yeast nutrient source, and an enzyme that releases fermentable carbohydrates from the starch hydrolysate to thereby provide a fermented beverage. The carbohydrate should consist essentially of free glucose and saccharide oligomers. In general, the carbohydrate is a hydrolysis product of granular starch, preferably a maltodextrin, and most preferably a maltodextrin from which fat and ash present in the granular starch have been removed. The soluble nitrogenous yeast nutrient source preferably is a yeast nutrient source that, when used in the fermentation, results in a product that is as organoleptically neutral as possible. The nutrient source preferably is present in an amount sufficient to sustain fermentation of the starch hydrolysate to an alcohol concentration that renders fermenting yeast inactive in a manner such that the yeast nutrient source is not rate limiting in the fermentation reaction. The method can comprise selecting for fermentation appropriate amounts of a starch hydrolysate, yeast, an enzyme that releases fermentable carbohydrates from the starch hydrolysate, and a soluble nitrogenous yeast nutrient source.

A fermented beverage prepared as heretofore discussed is itself a commercially valuable product. Generally, to prepare a product that is suitable for end user consumption, the fermented beverage is subjected to carbon filtration to substantially remove yeast flavors, thereby resulting in a remaining mixture. The remaining mixture is then subjected to ion exchange filtration to substantially remove salts and organic acids from the remaining mixture. If desired, coloring or flavoring agents may be added. A fermented beverage prepared in accordance with the inventive method also is provided.

Features of the preferred embodiments of the invention are described hereinbelow.

### DETAILED DESCRIPTION OF THE PREFERRED EMBODIMENTS

The invention is predicated, at least in part, on the desire to produce a non-distilled, fermented beverage that is colorless, flavorless, and odorless, and organoleptically neutral, i.e., lacking in distinctive character, aroma, odor, or taste. In preferred embodiments, the fermented beverage has the organoleptically neutral properties of a distilled grain neutral spirit that has been diluted with distilled water to the same alcohol content as the fermented beverage. In accordance with some embodiments of the invention, the fermented beverage can be modified after preparation to add flavorings and color and, if desired, to increase alcohol content. It is even possible in some embodiments of the invention that the fermented beverage is itself subject to distillation, although distillation is deemed unnecessary and hence undesired.

Starch hydrolysates are employed in accordance with the invention as a source of fermentable carbohydrates. The starch hydrolysate consists essentially of free glucose and saccharide oligomers, with little starch present and with as low an amount of other grain components present as is practicable. Most fermentations described in the prior art employ starch, which is hydrolysed in situ in the germinated grain or which is added as an adjunct. In accordance with the invention, at least 95% and preferably 100% of the carbohydrate content of the fermentation mixture is present in free form, with little or no other grain components being present.

It is contemplated that in most cases the starch hydrolysate should be a hydrolysis product of granular starch, such as a starch that has been hydrolysed via acid or enzymatic catalysis. Such products are composed of 90% or more, preferably 95% or more, and most preferably 98% or more by dry solids weight glucosidic units (which in the context of the present invention is deemed to include both glucose and saccharide oligomers). In preferred embodiments, fat and ash have been removed from the starch hydrolysate to yield a product that is composed of at least 99% and preferably essentially of 100% glucosidic units by dry solids weight, with essentially no other grain component being present. In highly preferred embodiments, the source of fermentable material consists essentially of a mixture of glucose and saccharide oligomers, the oligomers being α-1-4 or α-1-6 linked glucosidic oligomers. Generally, the starch hydrolysate used in conjunction with the invention is itself not directly fermentable, or is only partially fermentable. Only those saccharides in the mixture that have a degree of polymerization (“DP”) of 3 or less are deemed to be susceptible to fermentation. Such starch hydrolysates are generally known in the art and are available commercially, and include, for example, maltodextrins and syrup solids. The starch hydrolysate ideally has a dextrose equivalent (DE) of about 4 to about 70, preferably, a DE of about 10 to about 70 (e.g., a DE of about 10, about 20, about 30, about 40, about 50, or about 60).

Preferred starch hydrolysates are available commercially from Grain Processing Corporation of Muscatine, Iowa under the MALTRIN® trademarks. These include maltodextrins such as MALTRIN® M040 (DE=4), MALTRIN® M050 (DE=5), MALTRIN® M100 (DE=10), MALTRIN® M150 (DE=15), and MALTRIN® M180 (DE=18), and syrup solids such as MALTRIN® M200 (DE=20) and MALTRIN® M250 (DE=25). The MALTRIN® products are themselves substantially bland in flavor and consist essentially of mixtures of glucose and α-1-4 linked glucosidic oligomers from which fat and ash has been substantially removed. These products are composed of greater than 99.5% glucosidic units. Maltodextrins are highly preferred for use in conjunction with the invention, and the most highly preferred maltodextrins include MALTRIN® M100 and M180. Other starch hydrolysates (including blends and including sugar syrups and limit dextrins) may be used in conjunction with the invention.

Previous methods of producing fermented beverages include providing whole grain mashes as a carbohydrate source. Such grain mashes preferably are not used in conjunction with the invention, because fermentation of such mashes will result in a product with a grain-like flavor. The heretofore described starch hydrolysates yield fermented beverages that have a cleaner finish than may be attained using whole-grain carbohydrate sources.

The starch hydrolysate preferably is present in an amount of about 20% to about 25% solids (w/v) in an aqueous fermentation broth. The precise amount of starch hydrolysate for inclusion in the fermentation reaction is easily determined by the practitioner and is dependent on the parameters of the fermentation reaction, such as the volume of the fermentation broth, the desired alcohol content of the final fermented beverage product, and the amounts of yeast and enzyme. The amount of starch hydrolysate is ideally that which allows consumption of the carbohydrate thereby resulting in an alcohol content that is within 1% (absolute) of the inactivating alcohol concentration for the particular yeast used in connection with the fermentation reaction. Those skilled in the art will be able to determine the quantity of carbohydrate used in connection with this preferred embodiment. In other embodiments, a greater or lesser amount of carbohydrate may be employed. If a lesser amount of carbohydrate is employed, the fermentation will stop abruptly, thus leading to an alcoholic beverage with a lower alcohol content than is desired in preferred embodiments. A greater amount of carbohydrate may be employed if it is desired to impart the beverage with sweetness and/or carbohydrate “body” after fermentation.

The yeast employed to produce the fermented beverage can be any strain of yeast that ferments the carbohydrates released by starch hydrolysate to form alcohol. The yeast preferably does not produce byproducts which impart flavor or odor to the fermented beverage. Preferably, the yeast is a baker's yeast (i.e., a leavening yeast). The fermentation of carbohydrates by known brewer's yeasts, commonly used in beer production, can result in undesired taste components that are difficult to remove from the finished fermented beverage. For this reason, such yeasts are not deemed to be preferred. Use of baker's yeast, such as a suitable species of Saccharomyces (e.g., Red Star commercial baker's yeast), most preferably S. cerevisiae, is believed to minimize unwanted flavor contamination. The yeast can be grown aerobically in a medium similar to the fermentation broth using standard culture techniques, and added to the fermentation broth at an innoculum rate of about 1% to about 20% (v/v) (e.g., about 5% to about 10% (v/v)). Using such yeasts, it has been found that an alcohol concentration of approximately 10% to approximately 15% is inactivating. Other yeasts may remain active until higher alcohol concentrations are reached.

To achieve the desired taste-neutral fermented beverage product, the parameters of the fermentation reaction are selected so as not to stress the yeast. Stress responses in yeast are believed to result in the production of byproducts that impart unwanted flavor to the fermented beverage. For this reason, a nitrogenous yeast nutrient source also is provided in the fermentation broth. The nitrogenous yeast source is present for the purpose of sustaining health and allowing growth of the yeast during the fermentation reaction. In accordance with the invention, an amount of soluble nitrogenous yeast nutrient source is selected to ensure robust health of the yeast during the fermentation. In accordance with preferred embodiments of the invention, the yeast source is present in an amount sufficient to allow the yeast to achieve an inactivating alcohol concentration and such that the yeast nutrient source is not rate limiting during the fermentation. It is believed that the inclusion of lesser amounts of yeast nutrient source will cause the yeast to produce by-products (such as fusel oils) that can adversely affect the organoleptic properties of the fermented beverage. The amount of nitrogenous yeast nutrient source provided in the fermentation broth generally should be about 0.1% to about 5.0% (w/v) (e.g., preferably about 0.5% to about 3.0% (w/v)). The particular amount of nitrogenous yeast nutrient source may be determined by the practitioner based on the desired characteristics of the fermentation product.

In preferred embodiments, the nitrogenous yeast nutrient source is itself bland, and does not contribute significant levels of undesired flavor and odor components to the fermentation mixture. Most preferably, the yeast nutrient source is composed of at least 80% nitrogenous material, more preferably, at least 85%, more preferably, at least 90% and more preferably still, at least 95% nitrogenous material by dry solids weight. In conventional production of grain neutral spirits, corn steepwater frequently is employed as a nitrogenous yeast source. The nitrogenous content of corn steepwater typically ranges from 45-50% by dry solids basis, with the remaining components including sulfurous materials, phytic acid, lactic acid, ash, and other materials deemed undesirable in the context of the invention. Corn steepwater is malodorous and contributes significantly to flavor and odor of the fermentation mixture. This is not deemed to be a concern in the preparation of grain neutral spirits, because flavor and odor components of steepwater are substantially eliminated upon distillation. Because the invention seeks to provide a neutral beverage without the need for distillation, in accordance with the present invention, steepwater should not be used. To the contrary, in accordance with preferred embodiments, a nitrogenous yeast nutrient source that is organoleptically more neutral than corn steepwater from a commercial wet milling operation should be used.

The nitrogenous yeast nutrient source provides nutrients for yeast cells. Generally, the yeast extract should contain amino acids sufficient to sustain yeast growth without stressing the yeast. Although yeast are able to synthesize amino acids from nitrogenous sources, such synthesis often yields fusel oils and other undesirable byproducts which can adversely affect the organoleptic properties of the fermented beverage. For this reason, the yeast source should provide a sufficiently diverse profile of amino acids to minimize the formation of fusel oils in the fermented product. Ideally, the yeast nutrient source is a source of all of the amino acids normally required or synthesized by the yeast. In any event, the yeast nutrient source should contain a sufficient quantity and variety of amino acids such that the yeast nutrient source is not rate limiting in the fermentation reaction.

In highly preferred embodiments, the nitrogenous yeast source comprises the soluble fraction of hydrolyzed yeast (i.e., yeast extract). Yeast extract is believed to contain all of the amino acids required by the yeast to avoid rate-limiting phenomena in the fermentation reaction. Suitable yeast extract is available commercially from Red Star. Casein hydrolysate also is a suitable soluble nitrogenous yeast nutrient source, as are certain vegetable extracts (e.g. soy extract).

The starch hydrolysate generally will not be readily fermented by yeast. Accordingly, an enzyme is provided to break down the starch hydrolysate into fermentable sugars. Appropriate enzymes for use in the inventive method cleave fermentable carbohydrate molecules (DP less than or equal to 3) from the starch hydrolysate and are stable at the temperatures at which the fermentation reaction occurs. Preferably, the enzyme cleaves α-1,4 and/or α-1,6 oligosaccharide linkages in the starch hydrolysate. Glucoamylase (available from Genencor International) releases glucose subunits from starch hydrolysates and, accordingly, is useful in the context of the inventive method. Likewise, β-amylase, which cleaves maltose subunits leaving β-linked dextrins, and maltotriose-cleaving enzymes, which cleave maltotriose leaving limit dextrins, can be provided in the fermentation broth. If a β-amylase enzyme or a maltotriose-cleaving enzyme is employed, such are preferably used in conjunction with a starch debranching enzyme, such as pullulanase, to avoid leaving limit dextrin which would contribute to body in the fermented beverage. Multiple enzymes can be provided to efficiently generate fermentable sugars. The enzyme is preferably added in substantially free form, and is not bound with grain components or other components that would tend to add flavor or color to the fermentation. The enzyme should be added in an amount sufficient to prevent the release of fermentable carbohydrate from the starch hydrolysate from becoming rate limiting, or, conversely, from becoming so great as to cause sugar stressing of the yeast. Generally, the enzyme should be present in a sufficient amount to cause the percentage of fermentable carbohydrate in the fermentation mixture to remain at a level ranging from about 2% to about 5% by weight, based on the weight of the fermentation liquid, throughout most of the fermentation (at the end of the fermentation it is preferred that all dextrose be consumed by the yeast). Preferably the fermentable carbohydrate remains at this level though at least 90% of the fermentation time. To create a sweeter product, excess carbohydrate may be employed in the fermentation, and additional enzyme can be added (ideally after reaching an inactivating alcohol concentration) to create a higher sugar content in the fermentation product.

In practice, the relative amounts of each component of the fermentation reaction of the inventive method are selected to optimize the reaction for a fermented beverage having characteristics predetermined by the practitioner. The particular enzyme and starch hydrolysate, as well as the amounts of enzyme and starch hydrolysate, are selected such that the amount of fermentable carbohydrate released does not reach levels that stress yeast cells, as is understood in the art. Accordingly, the inventive method can comprise selecting the fermentation conditions and ingredients, including without limitation the amounts of starch hydrolysate, yeast, nitrogenous yeast nutrient source, and enzyme, that are sufficient to sustain fermentation of the starch hydrolysate to an inactivating alcohol concentration with minimal sugar- and nitrogen-related yeast cell stress. The parameters are preferably selected to minimize the amount of fusel oils, organic acids, and salts in the final product.

Fermentation is conducted under any suitable conditions that allow the enzyme to function, and are suitable for sustaining yeast and promoting fermentation of carbohydrates. For example, the fermentation can be performed at about 80° F. to about 98° F. for about 30 hours to about 48 hours, preferably in a closed vessel. No aging of the fermentation product is required (or desired in most embodiments). Preferably, no secondary fermentation step is employed. Fermentation preferably is conducted until the carbohydrate has been consumed, which, in preferred embodiments of the invention, will be at an alcohol concentration that is within 1% (absolute) of the inactivating alcohol concentration. In alternative embodiments, less carbohydrate amounts may be employed (thereby causing the reaction to terminate at a lower alcohol concentration), greater amounts of carbohydrate may be employed (thereby causing the reaction to terminate at the inactivating alcohol concentration and leaving carbohydrate in the product), or the reaction may be otherwise caused to terminate at an alcohol concentration that is less than the inactivating alcohol concentration.

The product of fermentation will be an alcoholic beverage, which may be referred to as a “fermentation beer.” The fermented beverage thus prepared is deemed to be a satisfactory and valuable commercial product. After fermentation, the yeast is removed from the fermentation beer using any suitable technique, such as centrifugation or filtration. While it is desirable to completely remove all yeast from the fermentation beer, this is not required. Additional rounds of filtration or other treatments can be employed to reduce the amount of yeast in the final fermented beverage.

If desired, the sediment-free fermentation beer can then be treated to reduce volatile and yeast-based contaminants or impurities which compromise flavor in the fermented beverage (e.g., acetaldehyde, methanol, propanol, and iso-amyl or iso-butyl alcohols). In one embodiment, the fermentation beer is treated with carbon (about 0.1% to about 3.0% (w/v)) to remove, for example, yeast-based impurities. Preferably, the inventive method comprises treating the fermentation beer with 1.5% carbon (w/v) for approximately 10 minutes to approximately 30 minutes to remove color and yeast-based flavor from the fermentation beer. The carbon is removed from the fermentation beer by conventional means, such as centrifuge or filtration. It will be appreciated that removal of all yeast-based contaminants is not required to create a fermented beverage with neutral flavor and color. By “substantially removing” contaminants is meant that a sufficient amount of contaminants are removed to provide a substantially flavor- and color-neutral fermented beverage.

To further remove impurities that affect flavor and color of the fermented beverage, the inventive method can further comprise substantially removing salts and organic acids which compromise flavor of the fermented beverage. In one embodiment, the salts and organic acids are removed by ion exchange treatment (e.g., cation-anion exchange filtration) of the fermented beverage (see, for example, European Patent 1,270,071, which discloses ion exchange treatment). Suitable ion exchange resins include, but are not limited to, strong acid and weak base resins. It will be appreciated that salts and organic acids need not be completely removed from the fermented beverage, but should not compromise the flavor or aroma of the fermented beverage. An additional carbon treatment can be performed to remove any flavor components introduced into the fermentation beer by the ion exchange filtration. It is contemplated that such treatments may reduce the alcohol content of the fermented beverage by dilution and/or elimination of ethanol.

The invention further provides a fermented beverage produced in accordance with the inventive method described herein. The fermented beverage is not distilled, yet embodies the desirable characteristics of flavor-neutral distilled spirits, namely the absence of flavor, aroma, and color, and, in highly preferred embodiments, the absence of perceptible residual carbohydrates or “body.” The color of the beverage may be evaluated via any suitable method. Preferably, the beverage is as colorless as possible. The beverage preferably is at least substantially free of sulfur flavors and odors, and is at least substantially free of other components that contribute to flavor and odor (e.g., diacetyl and esters).

The fermented beverage can be further processed to add flavorings or increase or decrease alcohol content. For example, flavor additives, such as citrus flavors or sugars, or color additives, such as food coloring, can be added to a fermented beverage that has been prepared in accordance with the foregoing teachings. The fermented beverage can be diluted to reduce alcohol content, e.g., to achieve an alcohol content of about 4% to about 6%. The fermented beverage also can be blended with distilled spirits, such as distilled grain spirits, to yield an alcoholic beverage. In such blends, the fermented beverage can account for any desired percent of the alcohol content of the alcoholic beverage. In some embodiments, for instance, the fermented beverage accounts for about 25% to about 75% (e.g. about 40% to about 60%) of the alcohol content of the alcoholic beverage. In other embodiments, the fermented beverage accounts for a higher percentage of the alcohol content, such as 80%, 85%, 90%, 95%, or 98% of the alcohol content. Some alcoholic beverages are prepared using flavoring agents that comprise distilled alcoholic solutions of flavor extracts (e.g. vanilla, lemon, or peppermint extract) or that otherwise are alcoholic. If such flavoring agents are used, these agents may contribute to the alcohol content of the alcoholic beverage, although the primary intent of adding such flavorings is not to increase the alcohol content.

The following examples further illustrate the invention but should not be construed as in any way limiting its scope.

### EXAMPLE 1

This example provides a method of producing a fermented beverage in accordance with the inventive method.

A fermentation reaction was performed using 230 g of a 10 DE maltodextrin and 10 g of soluble nitrogenous yeast nutrient source in a volume of 1.0 L. Approximately 35 ml to 70 ml of yeast propagation (i.e., yeast aerobically grown for 16 hours to 24 hours in medium similar to the fermentation broth) was added. Approximately 3.0 ml glucoamylase (50 units/ml) was provided to release fermentable carbohydrates from the maltodextrin. Fermentation was allowed to proceed anaerobically with minimal agitation at 90° F. for about 30 to about 48 hours to produce a fermentation beer with an alcohol content of 14% (slightly less than the 14.5% inactivating alcohol concentration for the species of baker's yeast that was employed).

The fermentation beer was centrifuged to remove yeast, and subsequently treated with carbon (4 g carbon per 200 ml fermentation beer) for 10 minutes at ambient temperature while stirring. The carbon was removed from the fermentation beer by filtration through Whatman #1 filter paper. The fermentation beer was then subjected to further treatment by adding approximately 20 g mixed bed ion exchange resin in the hydrogen and free base form per 200 ml fermentation beer. The ion exchange resin was stirred in the fermentation beer for approximately 10 minutes, and removed via filtration through Whatman #1 filter paper. A final carbon treatment (1.5 g carbon per 200 ml fermentation beer) was performed at room temperature for 10 minutes while stirring. The carbon was removed via filtration through Whatman #1 paper. The final alcoholic beverage had an alcohol content of about 12% (the alcohol content had been reduced slightly upon carbon treatment and ion-exchange treatment).

Evaluation of the resulted fermented beverage was performed by trained sensory professionals. The sensory panel classified the fermented beverage as “very clean” with no aftertaste. This example confirms the ability of the inventive method to produce a non-distilled, taste- and color-neutral fermented beverage.

### EXAMPLE 2

In this example, the fermented beverage prepared in accordance with one embodiment of the invention was evaluated against grain neutral spirits in a mixed drink.

A fermented beverage was prepared in a manner essentially identical to that of the beverage prepared in accordance with Example 1. A panel of adult volunteers was selected for the test. Candidates for the panel initially were screened for the four main senses, salt, sweet, sour, and bitter. Three people were eliminated for apparent taste blindness to bitter and/or sour tastes. The resulting panel consisted of fifteen women and thirteen men. The panelists were assigned random numbers for participation in the panel.

A forced-choice, “triangle test for similarity” was conducted. Each panelist was presented with three mixed drinks and asked to determine which of the drinks was different. Sample A was 50% v/v of store-bought SPRITE™ that was vacuum-filtered to remove carbonation, approximately 6% v/v grain neutral spirits (GNS), and about 44% v/v reverse osmosis water. Sample B was 50% v/v store-bought SPRITE™ that was vacuum-filtered to remove carbonation, and 50% v/v of the fermented beverage prepared in accordance with the invention (FB). The fermented beverage had an alcohol content of about 12%.

The panelists were given a numbered tray with samples labeled 1, 2, and 3 and were instructed to smell and taste the samples in order. The panelists were then to identify which sample was not the same as the other. Testing was done on Tuesday and Thursday mornings, with no eating or drinking one hour before the test.

The six different random possibilities of sample order presentation were as follows:

| 1 | 2 | 3 |
|---|---|---|
| A | A | B |
| A | B | A |
| A | B | B |
| B | A | A |
| B | A | B |
| B | B | A |

Twenty trays per day were put out for testing. Panelists were assigned a “1” for a correct choice and a “0” for an incorrect choice. The following table summarizes the test results.

| | | | | | | | | | % |
|---|---|---|---|---|---|---|---|---|---|
| Order | | | | dif- | Correct | | % | dif- | cor- |
| Values | #1 | #2 | #3 | ferent | choice | tests | correct | ferent | rect |
| 1 | A | A | B | #3 | 5 | 11 | 45.5 | #1 | 40.0 |
| 2 | A | B | A | #2 | 4 | 15 | 26.7 | #2 | 25.9 |
| 3 | A | B | B | #1 | 6 | 13 | 46.2 | #3 | 52.2 |
| 4 | B | B | A | #3 | 7 | 12 | 58.3 | | |
| 5 | B | A | B | #2 | 3 | 12 | 25.0 | | |
| 6 | B | A | A | #1 | 4 | 12 | 33.3 | | |
| | | | | Totals | 29 | 75 | 38.7 | | |

Using an upper one-tailed confidence interval statistical analysis, as described in Meilgaard, M., G. V. Civille, and B. T. Carr, Sensory Evaluation Techniques, CRC Press, Inc., Boca Raton, Fla. (1987) at Table T11 pg. 342, the hypothesis that “25% or less of the population will detect a difference in samples” was tested. This hypothesis was found to have succeeded at a 90% confidence level. The fermented beverage was deemed to be a suitable replacement for the diluted grain neutral spirits.

It is thus seen that the invention provides a neutral alcoholic beverage. In some embodiments, the invention provides an alcoholic beverage by adding flavor or color components to a neutral beverage that has been prepared in accordance with the foregoing teachings.

All references cited herein are hereby incorporated by reference.

All methods described herein can be performed in any suitable order unless otherwise indicated herein or otherwise clearly contradicted by context. The use of any and all examples or exemplary language provided herein is intended merely to better illuminate the invention and does not pose a limitation on the scope of the invention unless otherwise claimed. No language in the specification should be construed as indicating any non-claimed element as essential to the practice of the invention. Alcohol contents described herein are expressed on a percent by volume basis. Percentages expressed on a eight per volume (w/v) basis signify an amount equivalent to adding water to the weight in grams to yield 100 ml total volume.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for preparing a fermented beverage, comprising:
providing a starch hydrolysate, said starch hydrolysate consisting essentially of free glucose and saccharide oligomers, and, in the presence of yeast, a soluble nitrogenous yeast nutrient source, and an enzyme that releases fermentable carbohydrates from the starch hydrolysate, allowing fermentable carbohydrates to be released from said starch hydrolysate and allowing fermentation of said fermentable carbohydrates to proceed to yield a fermented beverage, wherein the soluble nitrogenous yeast nutrient source is more organoleptically neutral than corn steepwater and is present in an amount sufficient to sustain fermentation to an inactivating alcohol concentration in the fermented beverage without being rate limiting in the fermentation.

2. The method of claim 1, further comprising removing yeast from said fermented beverage.

3. The method of claim 2, said yeast being removed via centrifugation.

4. The method of claim 1, wherein the method further comprises substantially removing yeast-based contaminants which compromise flavor of the fermented beverage.

5. The method of claim 4, wherein the yeast-based contaminants are removed by treating the fermented beverage with carbon.

6. The method of claim 5, wherein the method further comprises substantially removing salts and organic acids which compromise flavor of the fermented beverage.

7. The method of claim 6, wherein the salts and organic acids are removed by ion-exchange filtration of the fermented beverage.

8. The method of claim 1, wherein the yeast is a baker's yeast.

9. The method of claim 8, wherein the yeast is a Saccharomyces yeast.

10. The method of claim 1, wherein said enzyme is present in an amount sufficient to sustain the level of fermentable carbohydrates in the fermentation mixture at a level of from 2-5% for at least 90% of the time of fermentation.

11. The method of claim 1, wherein said starch hydrolysate is a maltodextrin.

12. The method of claim 1, wherein said starch hydrolysate is syrup solid.

13. The method of claim 9, wherein said starch hydrolysate is present in an amount sufficient to allow fermentation to proceed to within 1% of the inactivating alcohol concentration for said yeast.

14. The method of 1, wherein the enzyme cleaves α-1,4 and α-1,6 oligosaccharide linkages in the starch hydrolysate.

15. The method of claim 1, wherein the enzyme is a glucoamylase.

16. The method of claim 1, wherein the enzyme is a maltotriose-releasing enzyme.

17. The method of claim 1, wherein the enzyme is a β-amylase.

18. The method of claim 1, wherein the soluble nitrogenous yeast nutrient source is present in the aqueous fermentation broth in an amount of about 0.5% to about 3.0% (w/v).

19. The method of claim 1, wherein the starch hydrolysate is a liquefied starch having a DE of less than 20.

20. The method of claim 1, wherein the starch hydrolysate is a liquefied starch having a DE of greater than or equal to 20.

21. A fermented beverage prepared in accordance with claim 1.

22. A diluted beverage comprising the fermented beverage of claim 21 diluted to an alcohol content of about 4% to about 6%, said fermented beverage having had a greater alcohol content prior to dilution.

23. A method for preparing a fermented beverage comprising selecting for fermentation an amount of a starch hydrolysate, an amount of yeast, an amount of an enzyme that releases fermentable carbohydrates from the starch hydrolysate, and an amount of a soluble nitrogenous yeast nutrient source sufficient to sustain fermentation to an inactivating alcohol concentration without being rate limiting in the fermentation and, in the presence of the yeast, the soluble nitrogenous yeast nutrient source, and the enzyme, allowing fermentable carbohydrates to be released from said starch hydrolysate and allowing fermentation of said fermentable carbohydrates to proceed to yield a fermented beverage, said starch hydrolysate consisting essentially of free glucose and saccharide oligomers, said nitrogenous yeast nutrient source being organoleptically more neutral than corn steepwater.

24. The method of claim 23, further comprising removing yeast from said fermented beverage.

25. The method of claim 23, wherein the method further comprises substantially removing yeast-based contaminants which compromise flavor of the fermented beverage.

26. The method of claim 25, wherein the method further comprises substantially removing salts and organic acids which compromise flavor of the fermented beverage.

27. The method of claim 23, wherein the yeast is a baker's yeast.

28. The method of claim 27, wherein the yeast is a Saccharomyces yeast.

29. The method of claim 23, wherein said starch hydrolysate is present in an amount sufficient to allow fermentation to proceed to within 1% of the inactivating alcohol concentration for said yeast.

30. The method of claim 23, wherein said starch hydrolysate is a maltodextrin.

31. The method of claim 23, wherein the enzyme is a glucoamylase.

32. A method for preparing an ion-exchanged fermented beverage, comprising:
providing a starch hydrolysate, said starch hydrolysate consisting essentially of a maltodextrin;
in the presence of a Saccharomyces yeast, a soluble nitrogenous yeast nutrient source, and an enzyme that cleaves oligosaccharide linkages in the starch hydrolysate to thus release fermentable carbohydrates from the starch hydrolysate, allowing fermentable carbohydrates to be released from said starch hydrolysate and allowing fermentation of said fermentable carbohydrates to proceed to yield a fermented beverage, the soluble nitrogenous yeast nutrient source being organoleptically more neutral than corn steepwater and being present in an amount sufficient to sustain fermentation to an inactivating alcohol concentration without being rate limiting in the fermentation;
removing yeast from said fermented beverage;
subjecting the fermented mixture to carbon filtration to substantially remove yeast flavors, thereby resulting in a remaining mixture; and
subjecting the remaining mixture to ion exchange filtration to substantially remove salts and organic acids to produce an ion-exchanged fermented beverage.

33. A method for substantially removing yeast-based contaminants from a fermented beverage, comprising:
providing a fermented beverage, said beverage having been prepared by providing a starch hydrolysate, said starch hydrolysate consisting essentially of free glucose and saccharide oligomers, and, in the presence of yeast, a soluble nitrogenous yeast nutrient source, and an enzyme that releases fermentable carbohydrates from the starch hydrolysate, allowing fermentable carbohydrates to be released from said starch hydrolysate and allowing fermentation of said fermentable carbohydrates to proceed to yield a fermented beverage, wherein the soluble nitrogenous yeast nutrient source is more organoleptically neutral than corn steepwater and is present in an amount sufficient to sustain fermentation to an inactivating alcohol concentration in the fermented beverage without being rate limiting in the fermentation; and
treating said fermented beverage with carbon.

34. A method according to claim 33, further comprising subjecting said fermented beverage after treating with carbon to ion-exchange filtration.

35. A method for preparing a fermented beverage, comprising:
providing a fermented beverage, said beverage having been prepared by providing a starch hydrolysate, said starch hydrolysate consisting essentially of free glucose and saccharide oligomers, and, in the presence of yeast, a soluble nitrogenous yeast nutrient source, and an enzyme that releases fermentable carbohydrates from the starch hydrolysate, allowing fermentable carbohydrates to be released from said starch hydrolysate and allowing fermentation of said fermentable carbohydrates to proceed to yield a fermented beverage, wherein the soluble nitrogenous yeast nutrient source is more organoleptically neutral than corn steepwater and is present in an amount sufficient to sustain fermentation to an inactivating alcohol concentration in the fermented beverage without being rate limiting in the fermentation; and
adding a flavoring agent to said fermented beverage.

36. A method according to claim 35, further including diluting said fermented beverage to decrease the alcohol content thereof.

37. A method according to claim 35, said flavoring agent comprising an alcoholic extract.

38. A method according to claim 35, said beverage having been decolorized.

39. A beverage prepared in accordance with claim 35.
